(19) United States
(12) Patent Application Publication
(10) Pub. No.: US 2005/0055757 A1
(43) Pub. Date: Mar. 17, 2005

(54) Potty shield

(76) Inventor: Deborah Lynn Boals, Colorado Springs, CO (US)

Correspondence Address: Deborah Lynn Boals, 4635 Poleplant Drive, Colorado Springs, CO, 80918, US

(21) Appl. No.: 10/941,160

(22) Filed: Sep. 15, 2004

Related U.S. Application Data
(60) Provisional application No. 60/503,318, filed on Sep. 16, 2003.

(51) Int. Cl. F15D 1/00; E03D 9/00

(52) U.S. Cl. 4/300.3

(57) ABSTRACT

The potty shield is a device that will sit on the back of the toilet seat or the rim of the bowl. Its purpose is to shield the tank or seat cover of the toilet from the urine of potty training boys and direct it into the toilet bowl. It will have two interlocking pieces allowing it to slide and span from the midpoint of the left side to the midpoint of the right side of the toilet bowl on different size toilets. There will be a horizontal attachment on each side approximately two-thirds the way down from the top allowing the device to rest on the back of the toilet seat or the rim of the bowl. There will also be handles on the top of each side allowing a person to pick up the device.

### CROSS REFERENCE TO RELATED APPLICATIONS

Priority is claimed to Provisional Patent Application Ser. No. 60/503,318, filed Sep. 16, 2003.

Also claimed is Design Patent Application Ser. No. 29/190,139, filed Sep. 16, 2003.

### STATEMENT REGARDING FED SPONSORED R & D

There is no federally sponsored research and development on the potty shield.

### REFERENCE TO A SEQUENCE LISTING, A TABLE, OR A COMPUTER PROGRAM LISING COMPACT DISC APPENDIX

Not Applicable

### BACKGROUND OF THE INVENTION

As we all know little babies must be potty trained. This invention relates specifically to boys who need to learn how to urinate standing up.

Presently all potty training devices are teaching boys to urinate sitting down. The current potty training devices are effective, but they don't allow the boys to urinate naturally by standing up. Most caregivers are also concerned with the mess of urine being sprayed on the tank or seat cover of toilets by the little boys who aren't tall enough to aim downward.

There is always a need for potty training devices that will effectively teach our little boys to go potty. This invention fulfills the needs of both boys and caregivers.

### BRIEF SUMMARY OF THE INVENTION

The Potty Shield is designed to enable potty training boys the option of standing at the toilet to urinate. The claimed Potty Shield will sit on the back of the toilet seat or the rim of the bowl and will be used to shield the tank or seat cover of toilets from urine by directing the urine into the toilet.

### DESCRIPTION OF THE FIGURES OF THE DRAWINGS

FIG. 1 is a front elevational view of the Potty Shield showing my new design;

FIG. 2 is a back elevational view showing the handles and toilet attachments;

FIG. 3 is a left side frontal view showing a handle and toilet attachment;

FIG. 4 is a right side frontal view showing a handle and toilet attachment;

FIG. 5 is a top plan view showing the handles and toilet attachments;

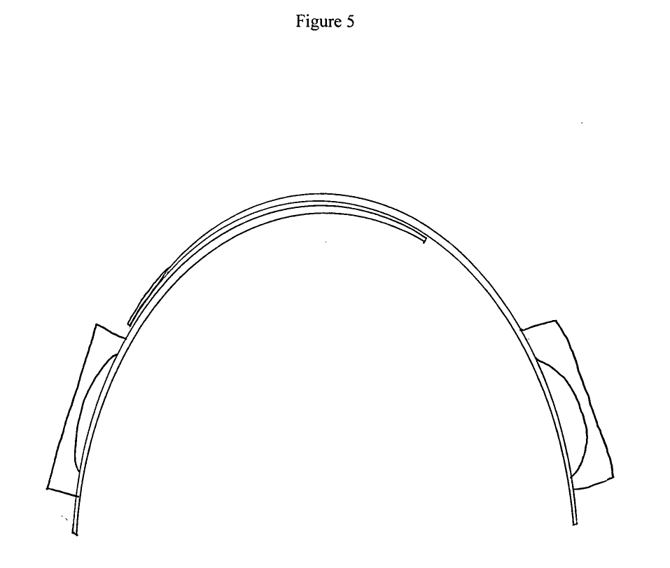

FIG. 6 is a bottom plan view showing the toilet attachments.

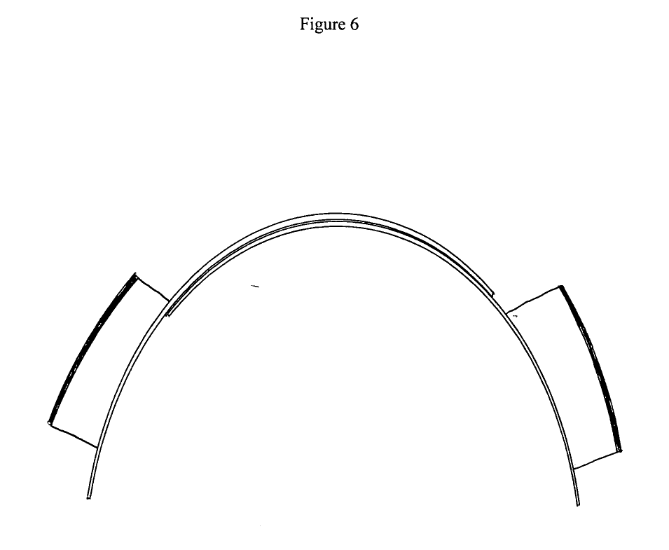

### DETAILED DESCRIPTION OF THE INVENTION

As illustrated in the drawings, the potty shield is a device that will sit on the back of the toilet seat or the rim of the bowl. Its purpose is to shield the tank or seat cover of the toilet from the urine of potty training boys and direct it into the toilet bowl.

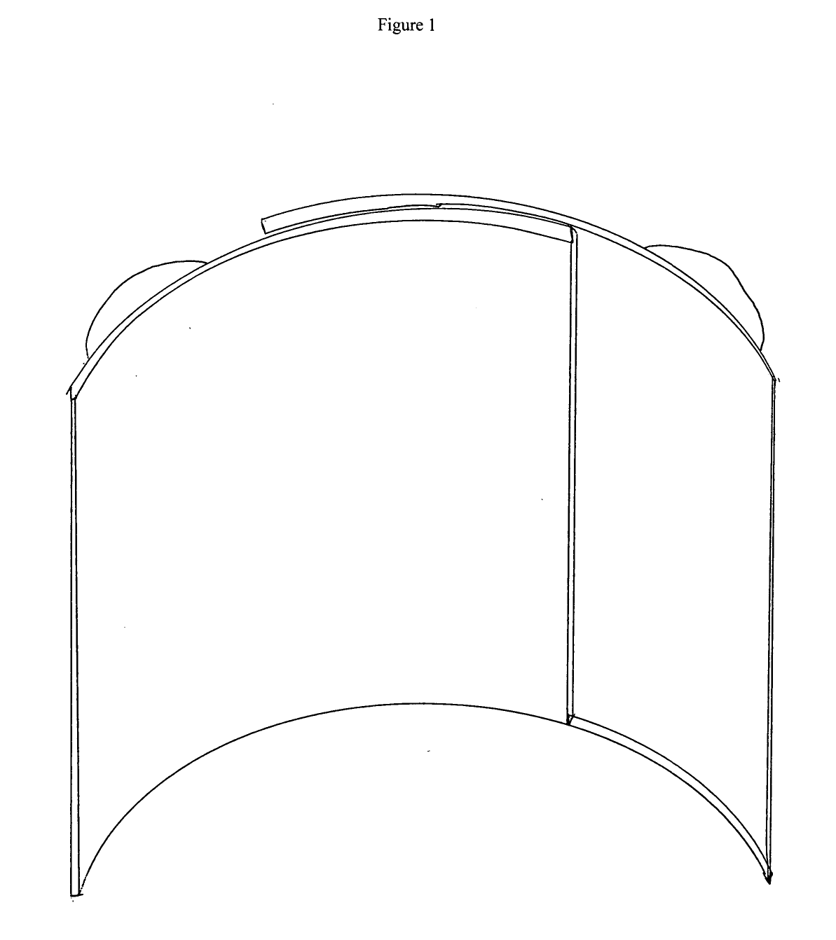

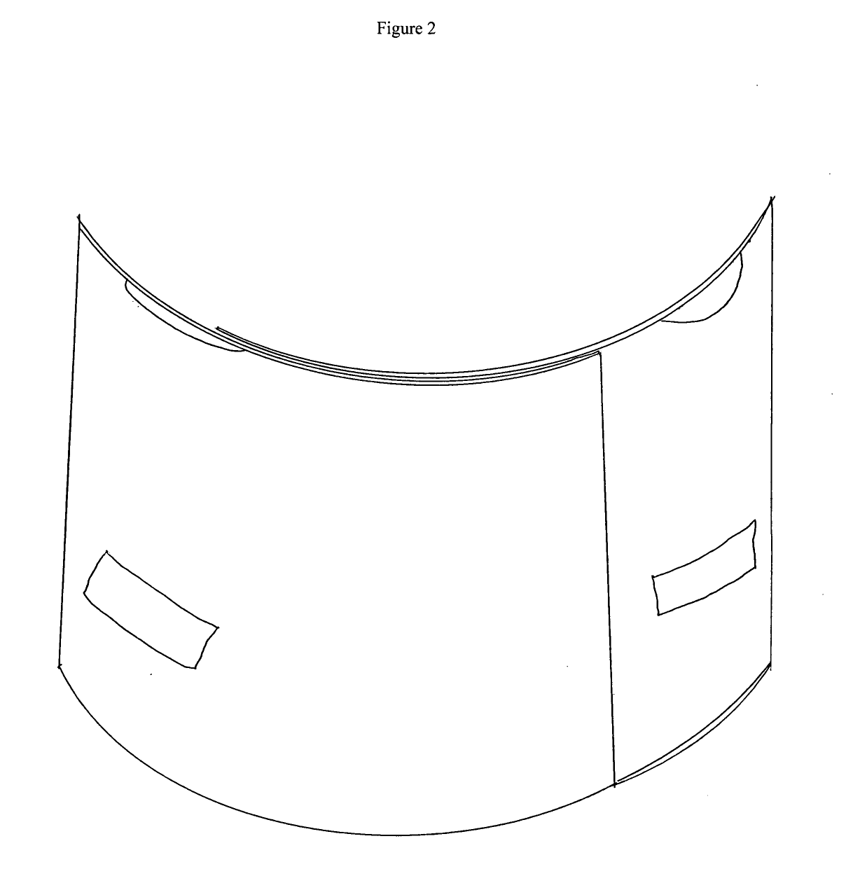

With reference to FIGS. 1-2, it will have two interlocking pieces allowing it to slide and span from the midpoint of the left side to the midpoint of the right side of the toilet bowl on different size toilets.

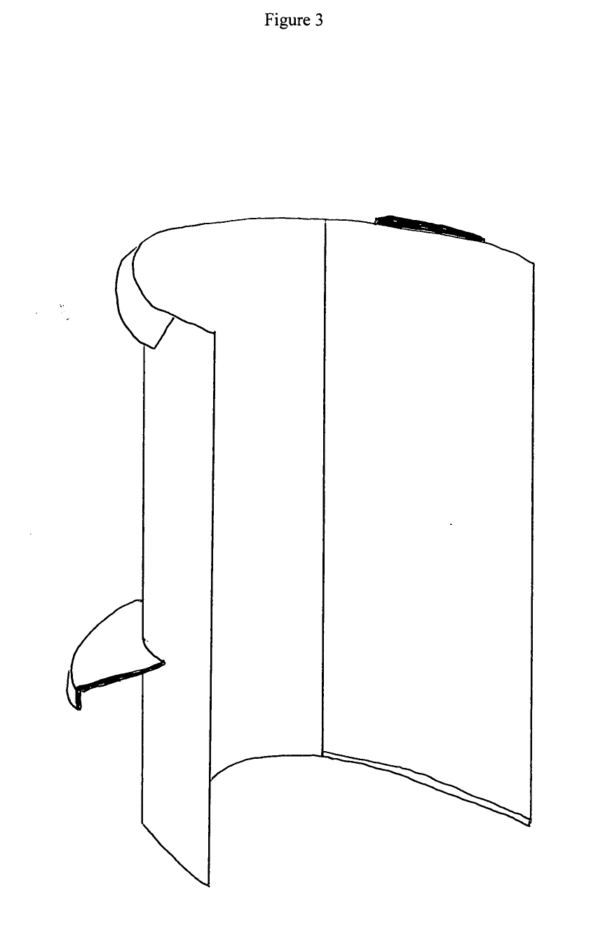

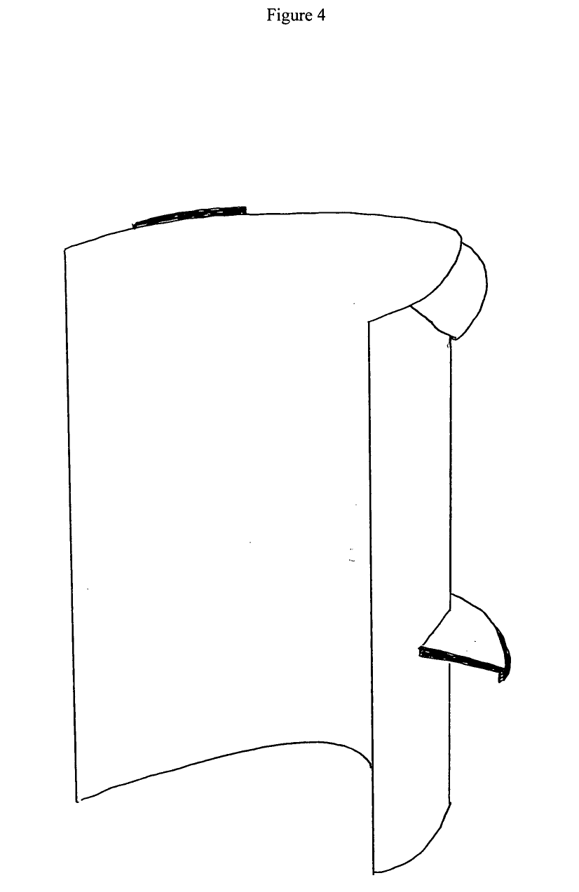

With reference to FIGS. 2-4, two-thirds of the device will be vertically out of the toilet and the other one-third will be vertically inside the toilet bowl directing the urine into the bowl. There will be a horizontal attachment on each side approximately two-thirds the way down from the top allowing the device to rest on the back of the toilet seat or the rim of the bowl. There will also be handles on the top of each side allowing a person to pick up the device.

It will be made from a non-absorbent, flexible material that will allow the two pieces to adjust to the toilet size.

1. I claim a potty training device comprising: a vertical attachment to the toilet that shields the tank and seat cover of the toilet from misdirected urine.

2. The potty training device of claim 1, further comprising: the vertical attachment is to sit against the sides and back edges of the inside rim of the toilet bowl or seat and direct urine into the toilet.

3. The potty training device of claim 1, further comprising: two interlocking pieces allowing it to adjust to the toilet size, two horizontal attachments allowing it to attach to the toilet, and two handles at the top allowing a person to remove it from the toilet.
